(19) United States
(12) Patent Application Publication
(10) Pub. No.: US 2017/0160788 A1
(43) Pub. Date: Jun. 8, 2017

(54) LOW POWER STATE RETENTION MODE FOR PROCESSOR

(71) Applicant: FREESCALE SEMICONDUCTOR, INC., Austin, TX (US)

(72) Inventors: YONGCAI HUANG, Shanghai (CN); WEIQIU YIN, Shanghai (CN)

(21) Appl. No.: 15/256,589

(22) Filed: Sep. 4, 2016

(30) Foreign Application Priority Data
Dec. 2, 2015 (CN) 201511035949.6

(51) Int. Cl. G06F 1/32; G06F 3/06

(52) U.S. Cl. CPC G06F 1/3287; G06F 3/0625; G06F 3/0634; G06F 3/0673; G06F 1/3225

(57) ABSTRACT

A method for conserving power in a computing device including a processor connected to an volatile system memory and having a processing core, always-on non-wakeup (AONW) resources, and a system memory controller, includes receiving a request at the processor to enter a low power state retention mode, saving, in the volatile system memory, control register settings for each of the AONW resources, placing the volatile system memory in a self-refresh mode to maintain all data stored in the volatile system memory, placing the system memory controller in a low power state, and turning off power to the processing core and all of the AONW resources.

### BACKGROUND

The present invention is directed to low power states for electronic devices such as computers, processors, and integrated circuits and, more particularly, to a low power state retention mode that extends standby time but also reduces the resume latency.

Computing devices, particularly portable computing devices such as tablets, cellular phones, electronic readers, and the like, often use operating systems that provide one or more low power states to allow a user to place the device into standby to save battery life. For example, such computing devices may utilize a “deep sleep” (DS) mode.” In DS mode, the operating system state is saved to a volatile system memory (e.g., dynamic random access memory (DRAM)), which is thereafter placed into a low power self-refresh mode. The processing core is then powered off while the operating system is kept alive in the volatile system memory.

However, many components and resources of the processor still receive power in the DS mode, which reduces the amount of time that the device can remain in standby. Other types of power saving modes have been proposed, akin to “hibernate” modes in personal computers, but the resume time from such modes tends to be unacceptably long for portable devices.

It is therefore desirable to provide a low power mode for a computing device that reduces the supplied power during standby and increases the length of standby time, while also reducing the time needed to resume to an active state.

### BRIEF DESCRIPTION OF THE SEVERAL VIEWS OF THE DRAWINGS

The present invention is illustrated by way of example and is not limited by embodiments thereof shown in the accompanying figures, in which like references indicate similar elements. Elements in the figures are illustrated for simplicity and clarity and have not necessarily been drawn to scale.

In the drawings:

FIG. 1 is a schematic block diagram of an exemplary computing device for use with embodiments of the present invention;

FIG. 2 is a schematic block diagram of a power signal distribution to the processor of the computing device of FIG. 1;

FIG. 3 is a flow chart of a process for entering LPSR mode in accordance with a preferred embodiment of the present invention; and

FIG. 4 is a flow chart of a process for resumption from LPSR mode in accordance with a preferred embodiment of the present invention.

### DETAILED DESCRIPTION

In one embodiment, the present invention provides a method for conserving power in a computing device including a processor connected to a volatile system memory. The processor includes a processing core, a plurality of always-on non-wakeup (AONW) resources, and a system memory controller. The method includes receiving a request at the processor to enter a low power state retention (LPSR) mode, saving, in the volatile system memory, control register settings for each of the AONW resources of the processor, placing the volatile system memory in a self-refresh mode to maintain all data stored in the volatile system memory, placing the system memory controller in a low power state, and turning off power to the processing core and all of the AONW resources of the processor.

In another embodiment, the present invention provides a computing device including a volatile system memory, and a processor connected to the volatile system memory. The processor includes a processing core, a plurality of always-on non-wakeup (AONW) resources, and a system memory controller. The processor is configured to receive a request to enter a low power state retention (LPSR) mode, save, in the volatile system memory, control register settings for each of the AONW resources, place the volatile system memory in a self-refresh mode to maintain all data stored in the volatile system memory, place the system memory controller in a low power state, and turn off power to the processing core and all of the AONW resources.

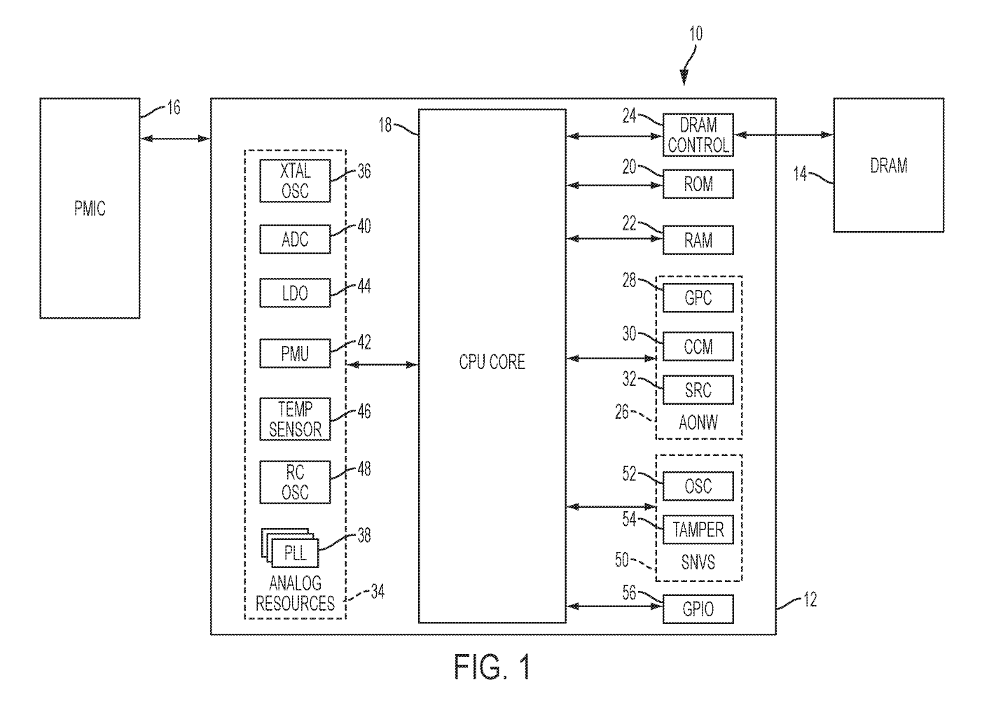

Referring now to the drawings, wherein the same reference numerals are used to designate the same components throughout the several figures, there is shown in FIG. 1 an embodiment of a computing device 10 in accordance with a preferred embodiment of the present invention. The computing device 10 preferably includes a processor 12, a volatile system memory 14, and a power management integrated circuit (PMIC) 16. Other components of the computing device 10, as are conventionally known, may be included as well, although are not shown in FIG. 1.

The processor 12 preferably has a system-on-chip (SOC) architecture, although other configurations may be used as well. For example, the processor 12 may be an i.MX7DUAL, available from Applicant. The processor 12 preferably includes one or more central processing unit (CPU) cores 18 configured to execute the majority of programming of the computing device 10, including the basic operating system, as well as control operation of various hardware components (not shown) of the computing device 10, such as memories, displays, user interfaces, speakers, microphones, communication modules, and the like. The processing core 18 may be, for example, a Dual CORTEX-A7 available from ARM LTD.

The processor 12 preferably further includes a read-only memory (ROM) 20, which is configured to store at least the boot program and other programming related to system initialization. The processor 12 also preferably includes an internal volatile memory 22 (e.g., random access memory (RAM)). The internal volatile memory 22 is preferably configured for receiving and storing programs for start-up or resume operations and other basic functions to be performed by the processor 12 without using the volatile system memory 14.

The volatile system memory 14 is preferably a dynamic random access memory (DRAM), although other types of volatile memory can be used as well, and serves as the storage and working space for the operating system and applications run by the processor 12. The processor 12 preferably includes a system memory interface 24 to allow the CPU core(s) 18 to control the volatile system memory 14.

The processor 12 further preferably includes a plurality of always-on non-wakeup (AONW) resources 26, which are components of the processor 12 that are normally always “on” for performing functions at the behest of the processing core(s) 18 running the operating system. However, these resources are “non-wakeup” because but a system interrupt generated by any of these components will not wake the system from a sleep mode. For example, the AONW resources 26 may include a general power controller (GPC) 28, a clock control module (CCM) 30, a system reset controller (SRC) 32, and the like, as well as various system interfaces (e.g., I2C, JTAG), graphics support units, general purpose timers, pulse width modulation units, and the like.

The processor 12 further preferably includes an analog resource domain 34, which preferably includes components such as one or more of the following: crystal oscillators 36, phase-locked loops (PLLs) 38, analog-digital converters (ADCs) 40, power management units (PMUs) 42, low dropout regulators (LDOs) 44, temperature sensors 46, RC oscillators 48, and the like. Much like the AONW resources 26, the components of the analog resource domain 34 typically will remain at least partially powered on during sleep modes of the device 10.

The processor 12 further preferably includes a secure non-volatile storage (SNVS) security module 50, which preferably includes components such as a secure oscillator clock 52 and a tamper detector 54. The processor 12 further preferably includes a general purpose input/output (GPIO) interface 56.

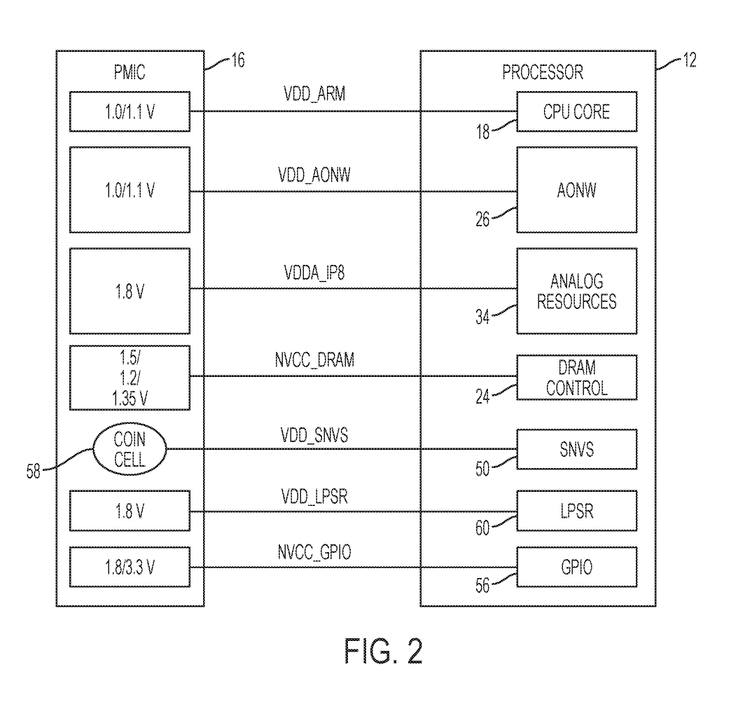

Referring to FIG. 2, the PMIC 16 preferably outputs a plurality of power signals to various domains (i.e., collections of components) of the processor 12. For example, in a preferred embodiment, the PMIC 16 provides a 1.0/1.1 V signal VDD_ARM to the processing core(s) 18, a separate 1.0/1.1 V signal VDD_AONW to the AONW resources 26, a 1.8 V signal VDDA_1P8 to the analog resource domain 34, a 1.5/1.2/10.35 V signal NVCC_DRAM to the system memory interface 24, and a 1.8/3.3 V signal NVCC_GPIO to the GPIO interface 56. The PMIC 16 preferably also uses a coin cell 58 to provide a power signal VDD_SNVS to the SNVS security module 50. Other components that will remain on in the LPSR mode may be in an LPSR domain 60, and receive a 1.8 V signal VDD_LPSR from the PMIC 16.

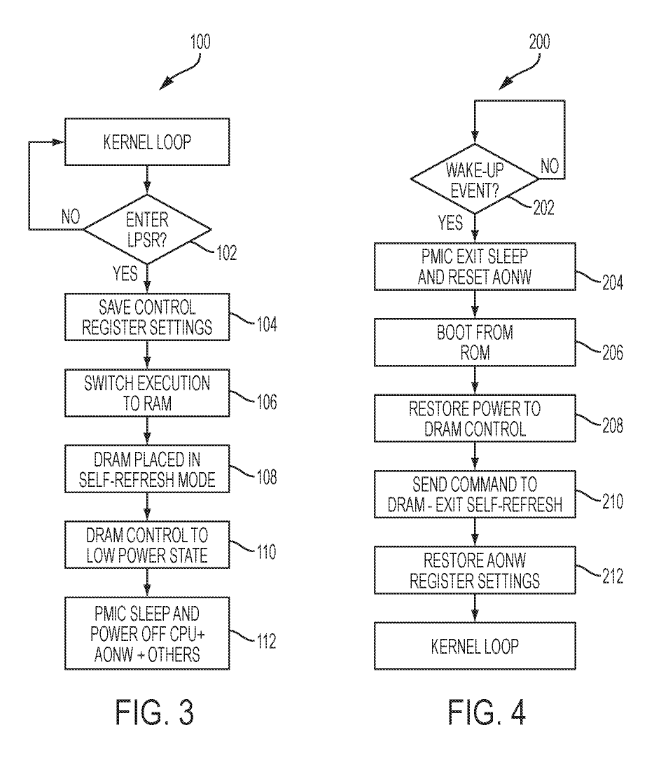

Referring to FIG. 3, a process flow 100 for placing the computing device 10 in the LPSR mode will now be described in accordance with a preferred embodiment. In normal operation, the processor 12 will run the operating system kernel, during which application programs may be executed by the processor 12 within the operating system. A request to enter the computing device 10 into LPSR mode may be received at step 102. The request may be explicitly selected by a user of the computing device 10, such as by selecting a displayed option to enter LPSR mode or the like. Alternatively, the request may be automatically received in response to a particular user action, such as pressing a power button or the like.

After receiving a request, the processor 12 at step 104 initiates a saving of control register settings for each of the AONW resources 26. The control register settings are representative of the state of each AONW resource, which will be restored upon a resume operation. The control register settings are preferably saved in the volatile system memory 14, which will remain powered on during the LPSR mode. However, the control register settings may be saved in other memories that will not be reset by entering the LPSR mode, such as external drives, eMMC cards, or the like.

At step 106, the processing core(s) 18 preferably switches code execution from the volatile system memory 14 to the internal volatile memory 22. The internal volatile memory 22 preferably stores a program for execution by the processor 12 to perform at least a portion of the remaining steps provided in FIG. 3. In particular, the processor 12 sends a command to the volatile system memory 14 to be placed in a self-refresh mode at step 108. In this mode, the volatile system memory 14 maintains all of the data stored therein, but is not accessed by the processor 12. At step 110, the system memory controller 24 is placed into a low power state. The PMIC 16 enables sleep, and at step 112, power is turned off to the processing core(s) 18 and the AONW resources 26. It is further preferable that power is also turned off to the analog resource domain 34. This differs from a conventional standby mode where only the processing core(s) 18 is powered off.

FIG. 4 shows an exemplary process flow 200 for resumption from LPSR mode in accordance with a preferred embodiment. The computing device 10 remains in LPSR mode until a wake request is received at step 202, which may be in the form of the user pressing a power button or the like. At step 204, the PMIC 16 exits sleep and the AONW resources 26 are reset. The processor 12 then boots from the internal ROM 20 at step 206. At step 208, full power is restored to the system memory controller 24 and at step 210, the processor 12 sends a command to the volatile system memory 14 to exit the self-refresh mode. At step 212, the previously saved control register settings are restored from the volatile system memory 14 so that the AONW resources 26 resume their states from just prior to entering LPSR mode. Once the AONW resources are restored, the processor 12 may re-enter the kernel loop.

It has been found that the LPSR mode described herein can save more than 75% of the suspend power of the processor 12 in computing devices utilizing the i.MX7DUAL. For example, Table 1 below shows power consumed in DS and LPSR modes when using an i.MX7DUAL processor with a 12×12 low power double data rate (LPDDR3) ARM2 board.

TABLE 1

| Power Signal | DS Mode | LPSR Mode |
|---|---|---|
| VDD_ARM | 0 mA @ 1 V | 0 mA @ 1 V |
| VDD_AONW | 0.95 mA @ 1 V | 0 mA @ 1 V |
| VDDA_1P8 | 0.05 mA @ 1.8 V | 0 mA @ 1 V |
| VDD_SNVS | 0.006 mA @ 3 V | 0.006 mA @ 3 V |
| VDD_LPSR | 0.02 mA @ 1.8 V | 0.02 mA @ 1.8 V |
| NVCC_GPIO | 0.023 mA @ 1.8 V | 0.023 mA @ 1.8 V |
| NVCC_DRAM | 0.0918 mA @ 1.8 V | 0.0918 mA @ 1.8 V |
| TOTAL | 1.261 mW | 0.261 mW |

An exemplary computing device 10 is provided as an e-reader, which may have a 1000 mAH battery, and typically is in a suspended mode 90% of the time. The total power consumption is a result of the processor 12 power added to the power supplied to the volatile system memory 14. A typical LPDDR2 memory has a self-refresh mode power consumption of about 0.36 mW. It can be calculated that a device utilizing DS mode has a battery life of about 2054 hours, while the same device using LPSR mode can provide a battery life of 5362 hours, an over 260% increase.

At the same time, for a computing device 10 running a LINUX kernel, a total resume time of about 30 milliseconds is exhibited, essentially because only one software step is added to the resume flow, i.e., restoring of the AONW resource hardware status. This adds only about a 10 millisecond latency as compared to resumption from DS mode.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that boundaries between the above-described operations are merely illustrative. The multiple operations may be combined into a single operation, a single operation may be distributed in additional operations and operations may be executed at least partially overlapping in time. Further, alternative embodiments may include multiple instances of a particular operation, and the order of operations may be altered in various other embodiments.

In the claims, the word ‘comprising’ or ‘having’ does not exclude the presence of other elements or steps then those listed in a claim. Further, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

1. A method for conserving power in a computing device including a processor connected to a volatile system memory, the processor including a processing core, a plurality of always-on non-wakeup (AONW) resources, and a system memory controller, the method comprising:
receiving a request at the processor to enter a low power state retention (LPSR) mode;
saving, in the volatile system memory, control register settings for each of the AONW resources of the processor;
placing the volatile system memory in a self-refresh mode to maintain all data stored in the volatile system memory;
placing the system memory controller in a low power state; and
turning off power to the processing core and all of the AONW resources of the processor.

2. The method of claim 1, wherein the processor further includes an analog resource domain receiving a separate power signal from the AONW resources, the method further comprising:
turning off power to the analog resource domain of the processor.

3. The method of claim 2, wherein the analog resource domain includes at least one of a crystal oscillator, a phase-locked loop, an analog-digital converter, a power management unit, a low dropout regulator, a temperature sensor, or an RC oscillator.

4. The method of claim 1, wherein the AONW resources include at least one of a general power controller, clock control module, or system reset controller.

5. The method of claim 1, wherein the AONW resources include a volatile memory storing a program that is executed by the processor to place the volatile system memory in the self-refresh mode.

6. The method of claim 1, further comprising:
receiving a wake-up request at the processor;
resetting the AONW resources;
booting from an internal read-only memory;
restoring full power to the system memory controller;
causing the volatile system memory to exit the self-refresh mode; and
restoring the previously saved control register settings for each of the AONW resources.

7. The method of claim 1, wherein the processor is a system-on-chip.

8. A computing device, comprising:
a volatile system memory; and
a processor connected to the volatile system memory, the processor including a processing core, a plurality of always-on non-wakeup (AONW) resources, and a system memory controller, the processor being configured to:
receive a request to enter a low power state retention (LPSR) mode,
save, in the volatile system memory, control register settings for each of the AONW resources,
place the volatile system memory in a self-refresh mode to maintain all data stored in the volatile system memory,
place the system memory controller in a low power state, and
turn off power to the processing core and all of the AONW resources.

9. The device of claim 8, wherein the processor further includes an analog resource domain receiving a separate power signal from the AONW resources, the processor being further configured to turn off power to the analog resource domain.

10. The device of claim 9, wherein the analog resource domain includes at least one of a crystal oscillator, a phase-locked loop, an analog-digital converter, a power management unit, a low dropout regulator, a temperature sensor, or an RC oscillator.

11. The device of claim 8, wherein the AONW resources include at least one of a general power controller, clock control module, or system reset controller.

12. The device of claim 8, wherein the AONW resources include a volatile memory storing a program that is executed by the processor to place the volatile system memory in the self-refresh mode.

13. The device of claim 8, wherein the processor is further configured to:
receive a wake-up request,
reset the AONW resources,
boot from an internal read-only memory,
restore full power to the system memory controller,
cause the volatile system memory to exit the self-refresh mode, and
restore the previously saved control register settings for each of the AONW resources.

14. The device of claim 8, wherein the processor is a system-on-chip.

15. The device of claim 8, wherein the volatile system memory is a dynamic random access memory (DRAM).
